(19) United States
(12) Patent Application Publication
(10) Pub. No.: US 2006/0185617 A1
(43) Pub. Date: Aug. 24, 2006

(54) Animal exercise and amusement device

(76) Inventor: Elizabeth Kenny, Flossmoor, IL (US)

Correspondence Address: HALLIHAN INTELLECTUAL PROPERTY LAW, LTD, Suite 2080, 125 South Wacker Drive, Chicago, IL, 60606, US

(21) Appl. No.: 11/399,994

(22) Filed: Apr. 7, 2006

Related U.S. Application Data
(63) Continuation-in-part of application No. 10/777,510, filed on Feb. 12, 2004, now abandoned.

(51) Int. Cl. A01K 29/00

(52) U.S. Cl. 119/707

(57) ABSTRACT

An animal exercise and amusement device for pets, particularly cats, for enabling a pet owner to interact with a pet without requiring the use of hands and enabling interaction without continuous active attention by the owner. The device includes a passive attachment device, and an amusement teaser, which is tethered to the passive attachment device. The tether may be of fixed length, or it may be elastic in nature.

This application is a continuation-in-part of U.S. patent application Ser. No. 10/777,510 filed 2 Dec. 2004 in the name of Elizabeth Kenny, which is incorporated herein by reference.

### BACKGROUND OF THE DISCLOSURE

1. Field of the Invention

The present invention relates in general to devices for providing exercise and amusement for animals, particularly house pets, and even more particularly, kittens and cats.

2. Background Art

Devices for providing exercise and amusement for animals have existed for many years, perhaps as long as man has had domesticated animals for pets. Certain such domesticated “pet” animals are particularly active by nature, and can derive benefit from an outlet for expending excess energy. Dogs and cats, especially cats, when left on their own, can become inquisitive and can disturb household articles and furnishings, in the process of expending excess energy and dissipating restlessness. Such animals (and their owners) can derive benefit from the animals' use of exercise and amusement devices.

Such exercise devices may often be in the form of statically suspended decorated objects, typically made to look like something that the particular animal might be curious about or attracted to, such as a bone or ball (dogs), or a bird or fish (cats). Such objects are often referred to as teasers by the industry. The objects typically may be suspended from a fixed position higher than the animal can reach from floor level, with a cord or string holding the actual object at a height near to or above the normal reach of the animal's paws. Alternatively, the object may be suspended by a cord, the far end of which is attached to a rod or shaft, the base of which may be at floor level or any other suitable location. The goal of the device is to attract, by its appearance, the animal's attention, causing the animal to swipe at the object. Contact with the object will cause it to swing and bounce about, further capturing the animal's attention, and causing it to further “chase” the now-moving object.

Such devices are disclosed in de Bruler, U.S. Pat. No. 2,194,736; Tae-Ho, U.S. 30 4,712,510; Matthews, U.S. Pat. No. 5,111,771; Krietsman et al., U.S. Pat. No. 5,474,032; Krietzman et al, U.S. Pat. No. 5,829,391; and Renforth et al., U.S. Pat. No. 6,318,300 B1.

While these “static” devices can be useful for providing periods of amusement to the animals, because they are tethered to a fixed base, there is a certain amount of limitation to the spontaneity and variety of activity that these devices can provide. Additionally, they lack interaction with humans, which domesticated household pets require for health and behavioral stability.

Accordingly, further exercise and amusement devices have been created that involve human interaction with the pet. Typically such devices involve replacing the fixed support for the tether with a handle, wand or the like, to be brandished by the pet owner or other human. Such devices enable a pet to interact with “its” human, enhancing the amusement experience and providing additional variability in the activity.

References that disclose such devices include Ament, U.S. Pat. No. 2,307,905; Galkiewicz, U.S. Pat. No. 4,499,855; Takahashi et al., U.S. Pat. No. 5,357,904; and Hass U.S. Pat. No. 5,961,406.

These references however, are configured to be hand-held by the human, and as such require continuous active attention and involvement by the individual. Recognizing that the amount of active attention that a person can provide to a pet is limited, it would be desirable to provide an animal exercise and amusement device which a person may employ that can provide such activity to an animal, while still providing a certain level of human interaction, without requiring continuous active attention on the part of the human.

It would further be desirable to provide an animal exercise and amusement device that not only provides exercise opportunities for the pet animal, but also enables the human pet owner to be mobile and engage in other activities, while simultaneously engaging in at least indirect interactive activity with the pet animal.

These and other desirable characteristics of the present invention will become apparent in view of the present specification, including claims, and drawings.

### SUMMARY OF THE INVENTION

The present invention comprises an animal exercise and amusement device, comprising a cuff, operably configured to be releasably affixed about a human limb; a tether, affixed at a first end thereof to the cuff; and a teaser, affixed to a second end of the tether.

In an embodiment of the invention, the cuff comprises a sack, containing 65 weighting material, for providing an exercise component to movements of a human to whom the cuff is releasably affixed. The cuff may further comprise a fastening strap, affixed to the cuff, in which the fastening strap has a first looped end and a second free end, with cooperative fastening elements, affixed to a surface of the fastening strap, proximate the first looped end and the second free end thereof, respectively; and a buckle, captured by the first looped end of the fastening strap, whereby the cuff may be wrapped about a human limb, and releasably affixed by passing the second free end of the fastening strap through the buckle, and turned upon itself, to bring the cooperative fastening elements against one another in releasably fastening contact.

Alternatively, the cuff may comprise a thin, elongated web having 75 opposed first and second ends, and opposed first and second surfaces; and cooperative fastening elements, one fastening element disposed on a first surface of the web at a first end thereof, and the other fastening element disposed on a second surface of the web at a second end thereof, whereby fastening of the cuff about a human limb is accomplished by wrapping the web about the limb, and directly bringing one of the cooperative fastening elements into direct contact with the other of the cooperative fastening elements, without folding or twisting the web.

The tether preferably may comprise an attachment portion, in the form of a loop, which encircles a portion of the cuff; and a teaser portion, which is affixed at a first end to the attachment portion, and further at a second end of which the teaser is affixed. Alternatively, the tether may comprise a single cord, affixed at its ends to the cuff and the teaser. In a preferred embodiment of the invention, at least a portion of the tether is fabricated from a stretchable material. Cooperative releasable fastener elements may be affixed to the tether and the teaser, so that the teaser may be removed from the tether and replaced by another teaser.

The teaser may have a shape that is at least one of ball-like, elongated, branched. Further, the teaser is preferably fabricated from at least one of: a smooth material, a rubbery material, a furry material, a feathery material, a fuzzy material, a spongy material. The teaser may be provided with a variety of depending objects of interest, each depending object of interest being at least one of: shiny, reflective, fluorescent, phosphorescent, transparent, translucent.

The invention may also include a wand member, interposed between the cuff and the tether, which includes at least one portion which has a level of resistance to bending which is greater than that of the tether. Further, a transition element may be provided, interposed between the wand member and the tether, which includes at least one portion which has a level of resistance to bending which is greater than that of the tether, but less than that of the at least one element of the wand member.

The present invention also comprises an animal exercise and amusement device, including a wand member; a transition element, extending from the wand member; a tether, extending from the transition element; and a teaser, affixed to the tether. The wand member preferably includes at least one portion which has a level of resistance to bending which is greater than that of the tether, and the transition element preferably includes at least one portion which has a level of resistance to bending which is greater than that of the tether, but less than that of the at least one element of the wand member.

### BRIEF DESCRIPTION OF THE DRAWINGS

FIG. 1 is a view of an animal exercise and amusement device according to one embodiment of the invention.

FIG. 1A is a view of a cuff for the animal exercise and amusement device according to the embodiment of FIG. 1, shown in its open configuration.

FIG. 2 is another view, from another perspective, of the animal exercise and amusement device according to the embodiment of FIG. 1.

FIG. 3 is yet another view, from still another perspective, of the animal exercise and amusement device according to the embodiment of FIG. 1.

FIG. 4 is a view of an animal exercise and amusement device according to another embodiment of the invention.

FIG. 5 is another view, from another perspective, of the animal exercise and amusement device according to the embodiment of FIG. 4.

FIG. 6 is yet another view, from still another perspective, of the animal exercise and amusement device according to the embodiment of FIG. 4.

FIG. 7 is a view of an alternative embodiment of the invention, in which a substantially rigid pole is interposed between the cuff and the tether.

FIG. 8 is a fragmentary view of an end of a tether, which is provided with a releasable fastener clip.

FIG. 9 is a view of another alternative embodiment of the invention.

FIG. 10 is a view of another alternative embodiment of the invention.

FIG. 11 is a side view of a handle of the invention depicted in FIG. 10.

FIG. 12 is a top view of the handle of FIG. 11.

FIG. 13 is a top view of a cuff and wand mount that can be used, for example, with the wands and/or handles of FIG. 10-12.

FIG. 14 is a side view of the cuff and the wand mount of FIG. 13.

FIG. 15 is a view of the wand mount of FIG. 13 without the cuff.

FIG. 16 is a view of the wand mount of FIG. 14 without the cuff.

FIG. 17 is a view of an alternative embodiment of the cuff and the wand mount.

FIG. 18 is a view of an alternative embodiment of a handle that can be used with the wand mount of FIG. 17.

FIG. 19 is a representative view of the various embodiments of the invention that use a cuff while in use.

### DETAILED DESCRIPTION OF THE INVENTION

While this invention is susceptible of embodiment in many different forms, there is shown in the drawings and will herein be described in detail, a preferred embodiment with the understanding that the present disclosure should be considered as an exemplification of the principles of the invention and is not intended to limit the invention to the embodiment so illustrated.

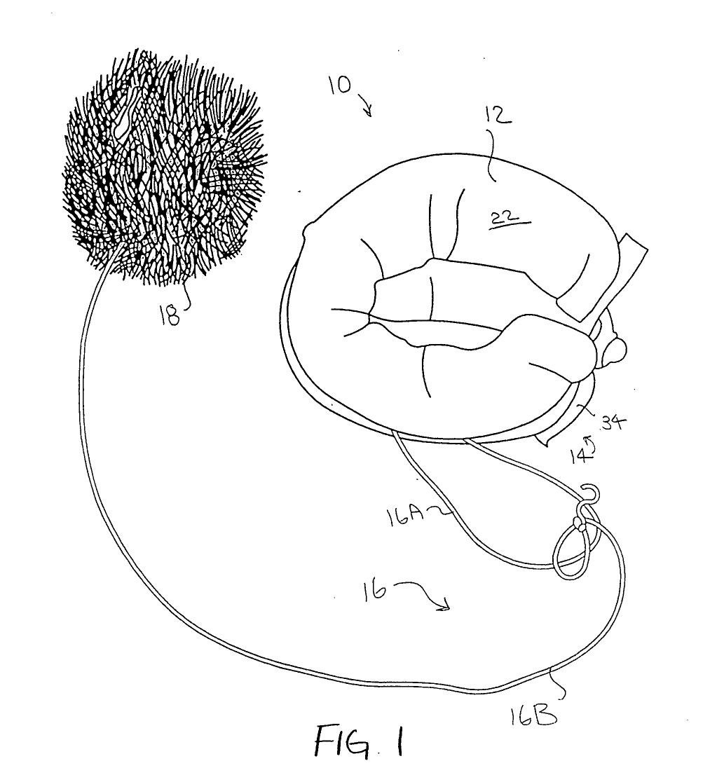

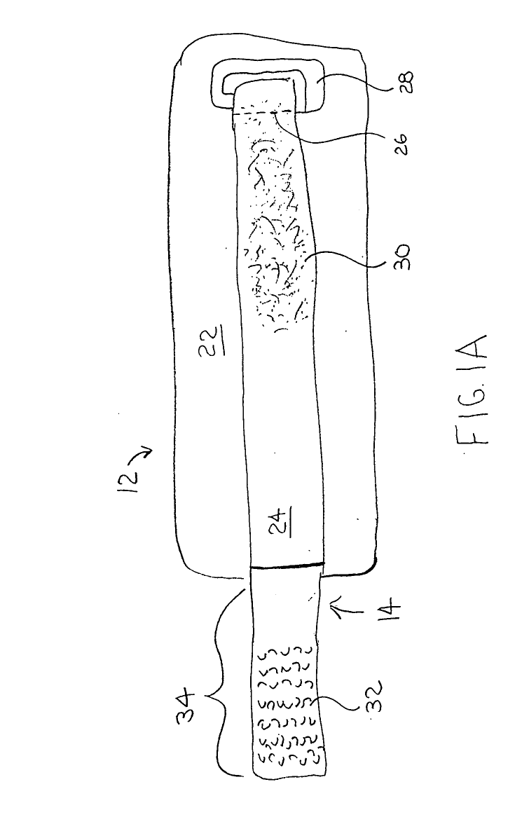

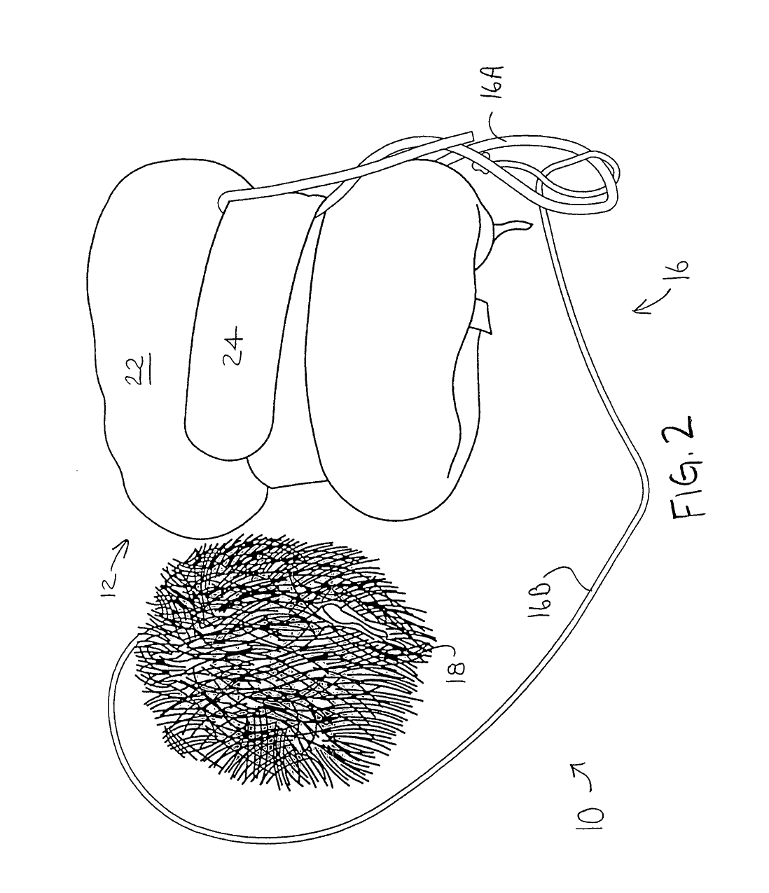

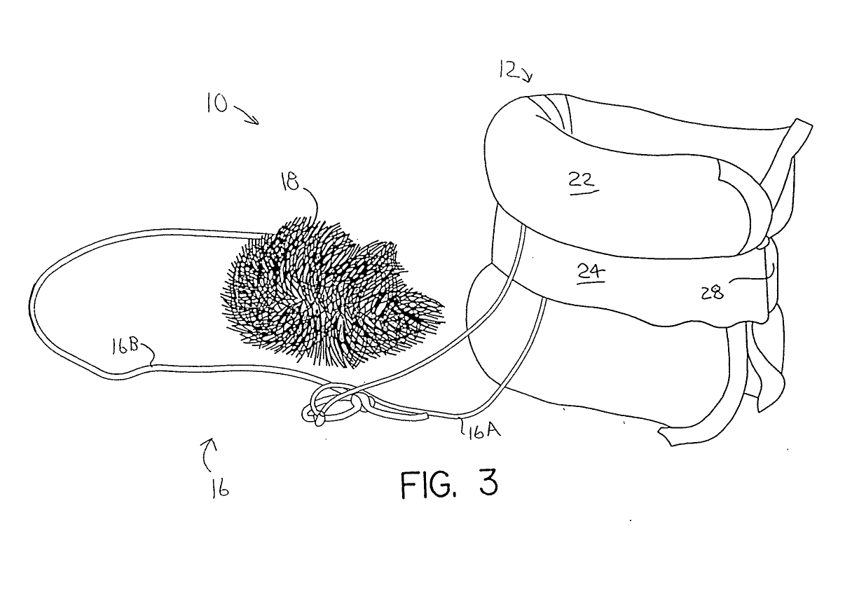

Animal exercise and amusement device 10, according to one embodiment of the invention, is shown in FIGS. 1-3. Device 10 includes cuff 12, fastener strap 14, tether 16, and teaser 18. Cuff 12 is intended (and is sized to be) to be placed in an encircling fashion about an ankle or leg, or arm or wrist, and is shown in its open configuration in FIG. 1A. Cuff 12 includes body 20, which may be preferably formed as a sack or enclosure 22, made from any suitable fabric or plastic material that will be comfortable and non-irritating to human skin, and filled with weighting material (sand or the like) so that cuff 12 acts as an exercise ankle (or arm) weight for the human. Alternatively, cuff 12 may be filled with any suitable padding or filling material, if additional weight is not desired.

Strap 14 comprises ribbon 24, again formed from any suitable material, which is affixed along a mid-portion thereof, to the sack portion 22 of cuff 12. One end of ribbon 24 is formed into a loop, e.g., by stitching 26 (which may be augmented or replaced by any other suitable fastening method, such as glue), to encircle one bight of buckle 28. Strap 14 additionally includes cooperating fastening elements such as loop elements 30 distributed on one side of ribbon 24, and hook elements 32, which are located on the same side, opposite free end 34 of ribbon 24. Fastening of cuff 12 about an ankle or arm is accomplished by wrapping sack 22 about the limb portion, until the opposing ends of sack 22 are brought into proximity with one another, passing free end 34 of ribbon 24 through buckle 28, and then drawing free end 34 of ribbon 24 upon itself and against the loop elements 30, as shown in FIGS. 1, 2 and 3.

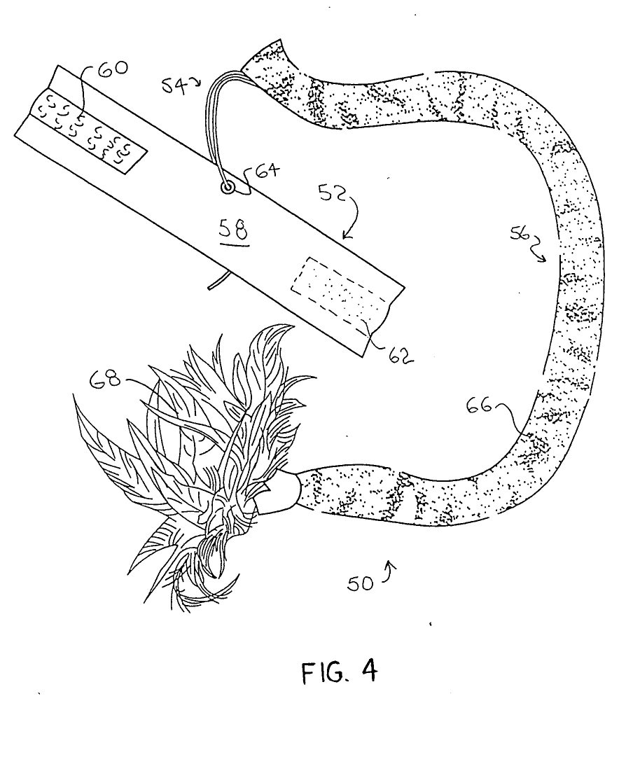

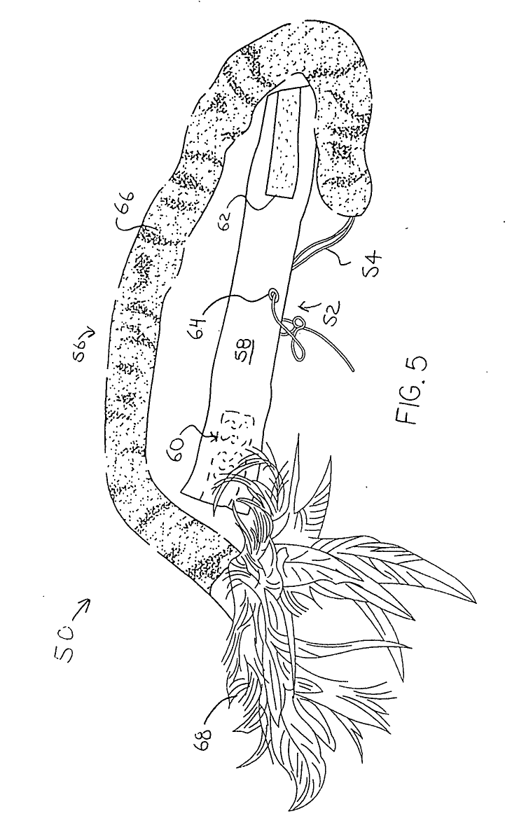

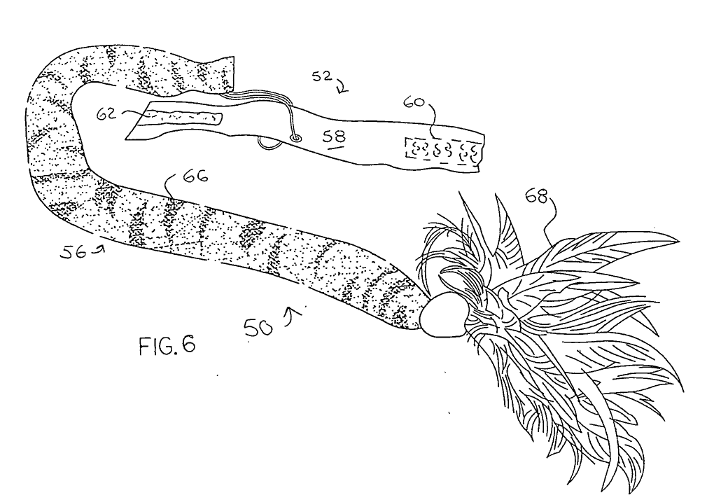

Tether 16, which may be a single contiguous element, or alternatively, as 160 shown, comprised of attachment portion 16A, and teaser portion 16B, is affixed to cuff 12, in an embodiment of the invention, by simply looping attachment portion 16A of tether 16 around free end 34 of strap 24, and knotting it securely, and then tying teaser portion 16B to attachment portion 16A. Alternatively, tether 16 may be permanently affixed to cuff 12 by any suitable means such as by stitching, gluing, threading it through eyelets (not shown) formed in sack 22, etc., or any combination thereof. Preferably, tether 16 is fabricated from a fiber or plastic cord material that has an ultimate tensile strength greater than a pet can be expected to exert, and not readily chewed through by an animal. In addition, tether 16 may be capable of limited stretching, to provide additional amusement action to the movement of the teaser 18. Alternatively, instead of being a cord, the tether may be formed as a teaser in itself, for example, in the form of a furred or feathery boa (such as shown with respect to the embodiment of FIGS. 4-6). In alternative embodiments, a plurality of strands may be employed, either in parallel, and/or in series, to form the tether, as may be desired.

Teaser 18 may be, as shown in the embodiment of FIGS. 1-3, a ball of fur (fake or real), or any other object of a suitable shape, configuration, material and appearance as would be attractive or interesting to the type of animal with which device 10 is intended to be used. The teaser may be a ball-like member, fabricated from at least one of a smooth material, a rubbery material, a furry material, a fuzzy material, a spongy material. Alternatively, the teaser may be an elongated or branched member, having a variety of depending objects of interest, that may be shiny, reflective, fluorescent, phosphorescent, transparent, translucent, etc. The term teaser is well known in the industry and the examples cited herein are merely meant to provide some examples of what a teaser can include. It should be noted that while the term teaser includes many objects of interest to an animal or that are otherwise attractive or interesting to the type of animal with which device 10 is intended to be used, a teaser only includes those objects on devices that are designed with the intent that the animal play with the object attached to the device. In other words, while a cat might be attracted to the movement of a dog collar that a person swings from a leash, such dog collar would still not fall within the term teaser because the dog collar and leash are not designed with the intent of being a plaything for a cat or other animal. If, however, a small object in the shape of a dog collar was included on a device where the small object was designed to be a plaything for an animal, then such object would fall within the term teaser.

Once device 10 has been attached to, typically, an ankle of an individual, that individual is then free to walk about (in a home, for example), with the teaser bouncing back and forth as a result of the leg movements. The pet (e.g., a cat) will see this continuously moving object, and become interested, and hopefully, attempt to pounce upon and grab the teaser, which, even if caught, will be pulled from the animal's grasp, if the human continues to walk or move about. Presumably, the pet will not be of sufficient size and strength that a human (even a small child) will be arrested in their movements or knocked down, should the animal obtain a firm grip upon the teaser 18 or the tether 16.

An alternative embodiment of the invention is illustrated in FIGS. 4-6. Device 50 includes cuff 52, tether 54 and teaser 56. Cuff 52 comprises a relatively thin (in the sense of thickness) web 58 (which may be fabricated from natural fiber, synthetic material or a combination thereof), which has cooperative fastening elements thereof, for example, hook elements 60 (on the side facing the observer of FIG. 4) and loop elements 62 (on the opposite side of web 58 and shown in broken lines). Attachment of cuff 50 is a simple matter of wrapping web 58 about the limb, and bringing loop elements 62 into contact with hook elements 60, and pressing them together, in the usual method of using such a fastening.

Tether 54, in this embodiment, is a length of cord or string, of any suitable material (which may be stretchable), that is passed through an opening (e.g., eyelet 64) in web 58, and knotted, so as to form a tether having two effective strands. Alternatively, a knot or any other suitable affixation method may be employed, to result in a single strand tether.

The opposite “end” of tether 54 is attached to teaser 56. Teaser 56 in this embodiment is in the form of a length of furred or fuzzy material 66, like a boa, which has, as a further attractive element, a feathery portion 68, which may be attached to the end of furred portion 66 by any suitable means.

The manner of play usage of device 50 of this embodiment is substantially the same as in the previously described embodiment, except that cuff 52 lacks the additional weight provided in cuff 12 of the first embodiment shown and described.

In each of the embodiments, the cuffs may be provided in different sizes, to enable both adults and children to use such devices.

In alternate embodiments of the invention, a rigid or semi-rigid pole may be affixed to the cuff, as shown in FIG. 7, in such a manner that the pole 70 is maintained at a more or less perpendicular orientation relative to the limb to which the cuff is attached. This may be accomplished, for example, by having a base disk 72 received in between opposing layers (or restrained behind a single layer) of the cuff 74. Pole 70 may be fabricated from a plastic or fiberglass material that is slightly flexible, but tends to a straight self-supporting orientation when not under load. This enables the teaser 76, connected by tether 78, to be held at a stand-off distance from the limb, which may be desirable, for a pets that may still have claws or a tendency to nip when excited. To the “free” distal end of the pole, the tether is attached, in any suitable manner, and then the teaser.

In still further embodiments of the invention, releasable clips 80 or other suitable releasable fasteners may be provided at one or both ends of the tether 82 (see, e.g., FIG. 8), to enable different types and styles of teasers 84 to be switched in and out, so that a variety of play modes are provided to maintain interest in the animal.

In the embodiments illustrated, the teasers are of the delicate variety favored by cats, but it is to be understood that, in alternative embodiments, more robust teasers (and tethers) may be employed for larger (or more rough playing) pets, such as dogs, ferrets, etc.

FIG. 9 illustrates an alternative embodiment of the invention (minus the cuff). Animal exercise and amusement device 100 includes an elongated wand 102, which may be fabricated from any suitable material, such as a relatively stiff plastic rod or tube. Connected to an end of wand 102 is transition element 104, which is a relatively shorter length of somewhat more flexible material, which may also be a length of plastic or rubber tubing, which is less resistant to bending, but does offer some resistance to bending. Extending from the end of transition element 104 is cord 106, which may be fabricated from an organic material such as cotton string, or preferably a polymeric material, that is highly flexible, yet resistant to breakage, fraying, chewing by an animal, etc. Cord 106 may be of a fixed length, or it may be made of a resilient, stretchable material, as described with respect to the previous embodiments. Teaser 108, shown in FIG. 9 as a grouping of feathers, is attached by tying, fasteners or adhesive or the like, to the end of cord 106, opposite to transition element 104. Animal exercise and amusement device 100 provides for improved “action” when in use in play with an animal, as the slightly flexible wand 102, and transition element 104 provide for more variable and interesting movements to be imparted to cord 106 and teaser 108. Although not shown in FIG. 9, it is to be understood that a relatively short-length wand 102 can be mounted to a cuff 74 as in the embodiment of FIG. 7, or to one of the other cuff configurations described herein, for an ankle or wrist mounted animal exercise and amusement device.

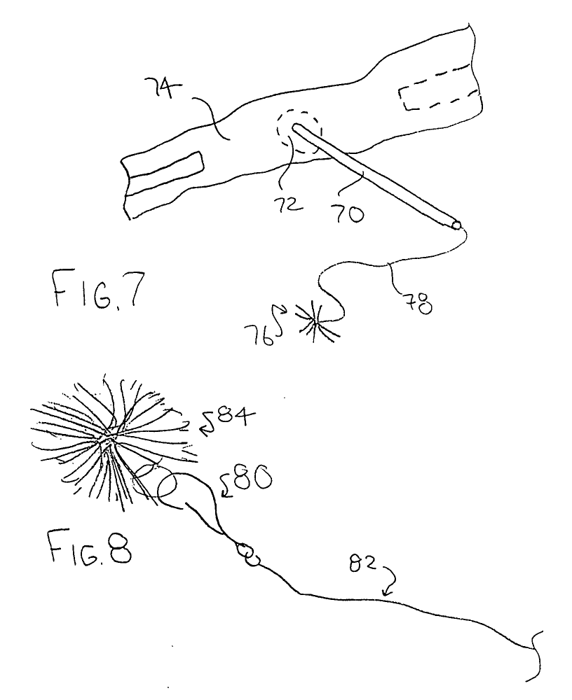

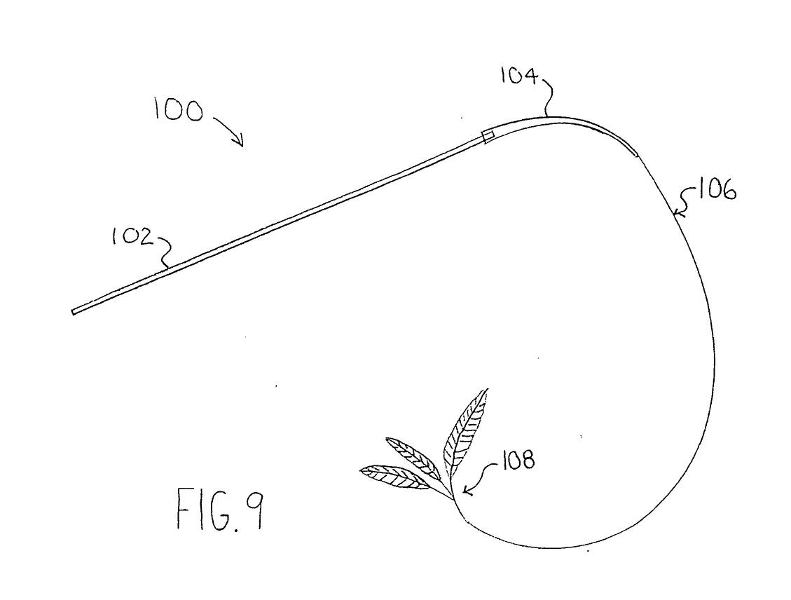

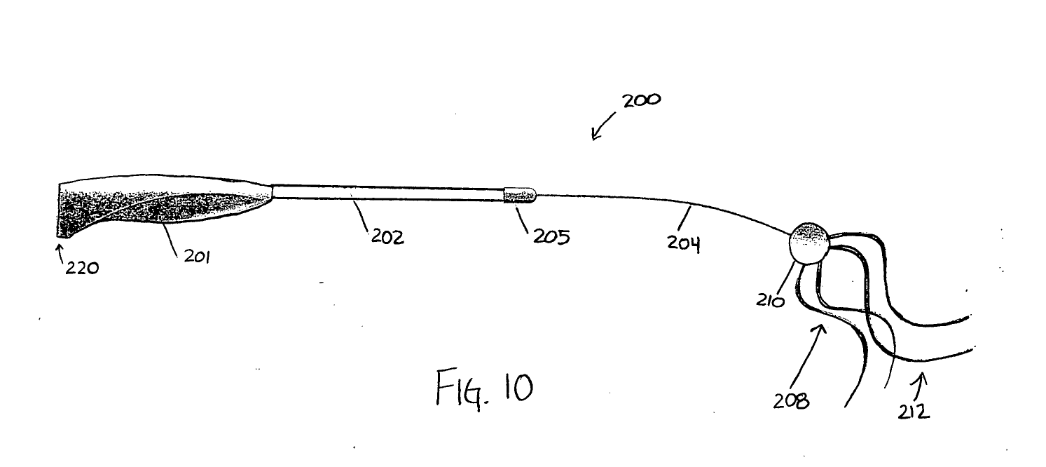

FIGS. 10-12 illustrate another alternative embodiment of the invention. Animal exercise and amusement device 200 includes an elongated wand 202, which may be fabricated from any suitable material, such as a relatively stiff plastic rod or tube. Connected to an end of wand 202 is flexible element 204 (a flexible wand like transition element 104), which is a relatively shorter length of somewhat more flexible material, which may also be a length of plastic or rubber tubing, which is less resistant to bending than elongated want 202, but (at least in one form) can also offer some resistance to bending. A handle portion 201 can be connected to an end of elongated wand 202 opposite the end connected to flexible element 204. Like the form in FIG. 9, a cord (not depicted) can extend from the end of flexible element 204. Teaser 208, shown in FIG. 10 as a ball 210 having a plurality of streamers 212 that can extend from ball 210 like tentacles from an octopus, is attached by tying, fasteners or adhesive or the like, to an end of flexible element 204. Animal exercise and amusement device 200 provides for improved “action” when in use in play with an animal, as the slightly flexible wand 202, and even more flexible portion (flexible element 104) provide for more variable and interesting movements to be imparted to teaser 108. In one form, flexible element 204 is connected to a connection cap 205 and connection cap 205 is then connected to wand 202 by any appropriate fastener, including glue, snap-fit, or with grooves on the interior of connection cap being screwed onto grooves on the outside of wand 202. Although not shown in FIG. 10, it is to be understood that this wand 202 can be mounted to a cuff 74 as in the embodiment of FIG. 7, or to one of the other cuff configurations described herein, for an ankle or wrist mounted animal exercise and amusement device. Indeed, the form shown in FIG. 10 is designed for the dual purpose of hand-held use and for attachment to a portion of the body, such as an arm or a leg so as not to require the use of a persons hand.

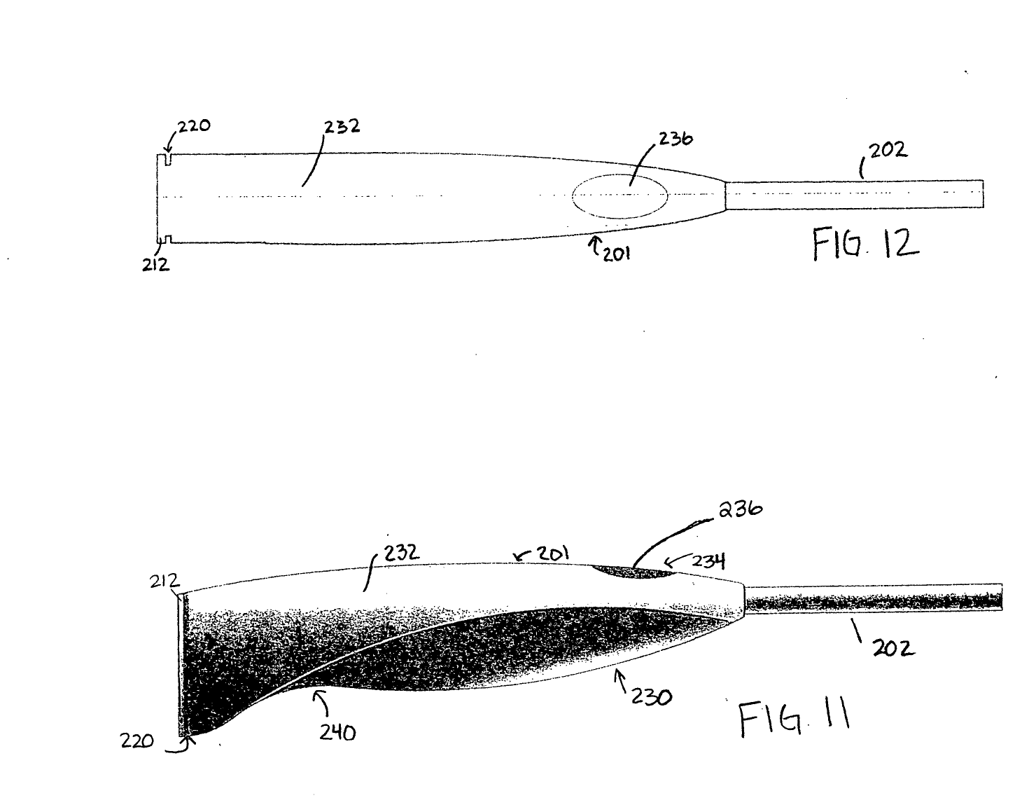

As seen more clearly in FIGS. 11-12, handle 201 can include a fastening feature, such as a slot, such as groove 220, (on the end opposite the end attached to wand 202) that can be formed in the handle at an end opposite the end attached to wand 202 for attachment to a cuff (like that cuff 74 of FIG. 7). In one form, handle 201 is a contoured handle, such as the ergonomic handle 201 depicted in FIGS. 11-12. Handle 201 can be molded as a single part or can be made from more than one component. In one form, handle 201 is made from two pieces that include a molded grip 230 made from real or synthetic rubber or other suitable material (preferably a soft somewhat yielding material like a rubber) and partial housing 232 that can be, for example, made from a suitable plastic material.

In the form depicted in FIGS. 11-12, partial housing 232 includes an opening 234 through which a thumb portion 236 of grip 230 is visible (an may even protrude) to provide a softer and somewhat yielding comfort thumb portion 236. In use, a person will place his thumb on thumb portion 236 with his hand wrapping around a portion of partial housing 232 such that at least one finger (and in most cases a plurality of fingers) rest on grip 230, such as by his fingers wrapping at least partially around grip 230. In this manner, handle 201 provides the user with a better grip surface and comfort associated from the rubber-like material of grip 230 while providing the rigidity and clean lines often associated by materials that are not rubber-like (such as plastic) of the material that forms partial housing 232.

Handle 201 can include a hand guard portion 240. Hand guard portion 240 allows the user to keep a firm grip on handle 201 and helps prevent the end opposite wand 202 from sliding through their fingers as they are moving 200 or if their pet gets a good grip on teaser 208. In one form, (see FIG. 11) hand guard portion 240 of handle 201 tapers outward in the rearward direction from where the user would normally grip handle 201 during use without a cuff. Like the hand guard on knifes that are not designed for fighting, hand guard portion 240 can be any other upwardly projecting portion that is designed to prevent the hand from sliding past such portion. Ergonomic handle 201 and grip 230 can take many forms. In one form, grip 230 can have a profile that is at least somewhat concave and in another form it can have a profile that is at least somewhat convex.

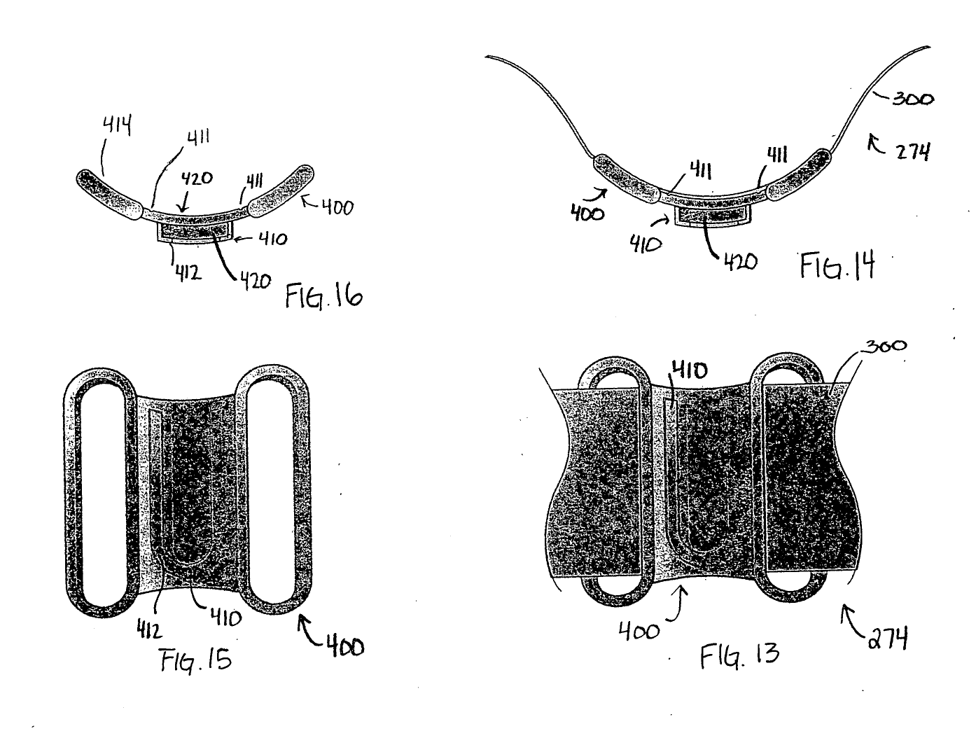

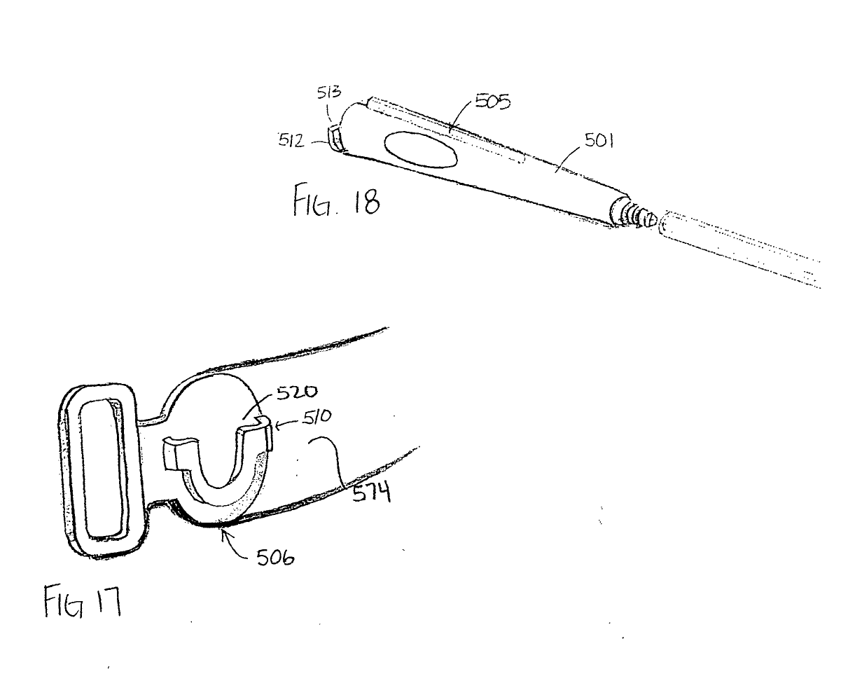

FIGS. 13-14 show another embodiment of a cuff 274 that can be used with device 200. In this form, cuff 274 can be made from a band 300 that can be an elastic band of material, such as elastic or other suitable material, or another sort of cuff like those previously described. In this form, a cuff attachment 400 is used to attach the device 200 to cuff 274. In one form, cuff attachment piece can be a clasp, like the clasp depicted in FIGS. 13-16 or the buckle of FIG. 17. Cuff attachment can be securely attached to cuff 274 and can be either permanently attached to cuff 274 or removeably attached to cuff 274. For example, cuff 274 can be made from an elastic band that has both ends sewn together after the elastic band has been properly threaded through the clasp shown in FIGS. 13-17. Cuff attachment 400 includes a wand mount 410 attached to cuff attachment 400. In the depicted form, wand mount 410 is an integral part of cuff attachment 400 and can be manufactured of any suitable material, such as molded plastic. Cuff attachment 400 is preferably flexible in at least the direction that cuff 274 wraps around a persons body.

In one form, a plurality of notches 411 are formed on the surface of cuff attachment 400 that is nearest a person's body during normal use to allow added flexibility of cuff attachment 400. In an alternative form (not shown) additional notches can be added on the opposite surface and generally located opposite notches 411 to increase flexibility. Cuff attachment 400 (and even clasp 410) can have a concaved surface 414 on the surface closest to a person's body during normal use to approximately fit the contour of the person during use and allow for a more comfortable fit.

In one form, wand mount 410 is a connection piece that handle 201 slides into and couples handle 201 to cuff 274. Wall mount 410 and handle 201 can have complementary recessed slots or grooves 220 (and/or 420) and extending tabs 412 (and/or 212) that fit within such recesses. Wand mount 410 can be a somewhat u-shaped portion that extends outward from clasp 410 and forms a recessed slot or groove, such as channel 420 that is formed between the surface of the rest of clasp 410 and the extending tabs 412. The grooves 220 of handle 201 form tabs 212 (FIGS. 11-12) near the end of handle 201 that is opposite the end attached to wand 202. Tabs 212, 412 and grooves 220, 420 are complementary designed so that tab 212 fits within groove 420 and tab 412 fits within groove 220 in a relatively snug manner such that tabs 212, 412 are held in a sufficiently secure manner by grooves 220, 420. While two tabs 212, 412 and grooves 220, 420 have been depicted, a single tab and groove could be used, instead.

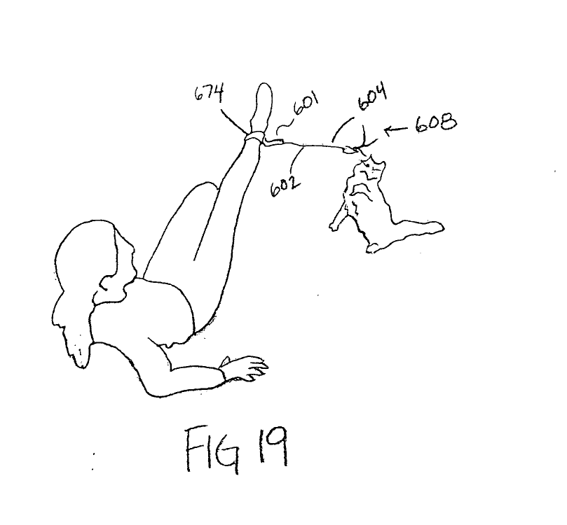

FIGS. 17 and 18 depict another form of cuff 574 and cuff attachment 500. In this form, cuff attachment 500 is a clasp in the form of a buckle or buckle-like device. In this form, only one tab 512 is used to mount handle 501 to wand mount 510. In this case, tab 512 extends outward from (and approximately half-way around) the surface of handle 501. Handle 501 is hollow and has a slot 505 in its surface that starts at the end that is coupled to wand mount 510 and extends toward the opposite end. Tab 512 is slipped inside groove 520 and are sized such that tabs 512 contacts groove 520 such that handle 501 is squeezed (with slot 505 allowing the handle to contract or bend by slot 505 becoming smaller) until tabs 512 are past groove 520. Slot 505 goes back to its normal size causing handle 501 to return to its normal shape such that tabs 512 cannot be removed without squeezing the handle. Other snap-fit forms of attaching handle 501 to wand mount 410 can also be used. For example, handle 501 could be a solid handle and slot 505 could extend all the way through the handle. Tab 512 would be replaced by two tabs, basically ears, on either side of slot 505. The handle would then be attached and detached in a similar manner.

FIG. 19 shows an example of basically any of the animal exercise devices that can utilize cuffs when they are being used with a cuff. In each case, the cuff 674 is preferably configured and attached to the rest of the device so that the person using it is not required to hold onto or provide additional support to the handle, wand, flexible element teaser or any portion of the device. Basically, only the cuff itself is needed to contact a portion of the persons body (including clothed portions) in order to provide adequate support to the rest of the device. In one form, wand and cuff are connected together such that in use, wand extends outward from the cuff without relying on gravity and without resting on, or gripped by, another object (such as the user's fingers). In one form, the wand extends outward and is approximately perpendicular to the cuff, as shown in FIG. 19. The cuff allows the device to be used both for exercise of the animal and the human. A person can do leg raises or arm stretches to exercise themselves while their cat, or other animal, enjoys exercise by playing with the teaser that is coupled to the human.

In each of the cuff described above, the cuff is preferably sized appropriately for attachment to the ankle, wrist, leg or arm of a person. In another form, the cuff is preferably sized appropriately for attachment to the waist of a person. In any event, the cuff is preferably designed to provide a comfortable fit around a person's body and is made from appropriate materials. The cuff is preferably designed to fit snugly around the person's body and preferably conforms to the shape of a persons body in order to prevent (or minimize) the cuff (and teaser) from moving around the circumference of the portion of the body that the cuff is attached to.

The foregoing description and drawings merely explain and illustrate the invention, and the invention is not so limited as those skilled in the art who have the disclosure before them will be able to make modifications and variations therein without departing from the scope of the invention.

What is claimed is:

1. An animal exercise and amusement device, comprising:
a cuff, operably configured to be releasably affixed snugly about a human limb;
a tether, affixed at a first end thereof to the cuff; and
a teaser, affixed to a second end of the tether.

2. An animal exercise and amusement device, comprising:
a cuff, operably configured to be releasably affixed about a human limb;
a pole having a first end coupled to the cuff and a second end;
a teaser coupled to the a second end of the pole;
wherein the cuff supports the pole without requiring a user to hold the amusement device.

3. The animal exercise and amusement device, according to claim 2, wherein the pole is adapted to hold the teaser at a distance away from the cuff.

4. The animal exercise and amusement device, according to claim 2, wherein the pole is a flexible pole.

5. The animal exercise and amusement device, according to claim 2, further comprising a tether coupling the teaser to the second end of the pole, the tether being located between the teaser and the second end of the pole.

6. The animal exercise and amusement device, according to claim 5, wherein the pole is adapted to hold the teaser at a distance away from the cuff.

7. The animal exercise and amusement device, according to claim 6, wherein the pole is substantially rigid and further comprising a flexible element coupling the teaser to the second end of the pole, the flexible element being located between the teaser and the second end of the pole, wherein the flexible element is more easily flexed than the pole.

8. A dual usage animal exercise and amusement device, comprising:
a wand having first and second ends;
a handle having first and second ends, the first handle end coupled to the first wand end;
a teaser coupled to the second wand end;
the second handle end operably configured to be releasably affixed to a wand mount.

9. The dual usage exercise and amusement device of claim 8, further comprising a wand mount, the wand mount operably configured to be releasably affixed to a person.

10. The dual usage exercise and amusement device of claim 9, further comprising a cuff coupled to the wand mount, the cuff operably configured to be releasably affixed to a person.

11. The dual usage exercise and amusement device of claim 10, further comprising:
at least one tab coupled to one of the wand mount and the second handle end;
at least one groove couple to the other of the wand mount and the second handle end;
wherein the tab and groove are operably configured to releasably couple the wand mount and the second handle end.

12. The dual usage exercise and amusement device of claim 1 1, wherein the handle comprises includes a thumb grip and a finger grip, the thumb grip operably configured to provide a grip for the thumb and the finger grip is operably configured to provide a grip for the fingers when the handle is gripped by a user.

13. The dual usage exercise and amusement device of claim 12, wherein the thumb grip and the finger grip are made from a material that is softer than other portions of the handle.

14. The dual usage exercise and amusement device of claim 13, wherein the thumb grip and the finger grip comprise one integral piece, with the thumb grip extending through an opening in said other portions of the handle that surround the thumb grip.
